(19) United States
(12) Patent Application Publication
(10) Pub. No.: US 2022/0277608 A1
(43) Pub. Date: Sep. 1, 2022

(54) BAKED PRODUCT KIOSK

(71) Applicant: The Wilkinson Group LLC, Walla Walla, WA (US)

(72) Inventors: Paul Wilbur Heisey Brandauer, College Place, WA (US); Eric James Wilkinson, Walla Walla, WA (US); Randall Wilkinson, Hayden Lake, ID (US); Denver Allan Wilkinson, Couer d'Alene, ID (US); Ronald Jay Wilkinson, Walla Walla, WA (US); Thomas Richard Mann, Acworth, GA (US)

(21) Appl. No.: 17/753,188

(22) PCT Filed: Sep. 4, 2020
(86) PCT No.: PCT/US2020/070505

§ 371 Date: Feb. 23, 2022

Related U.S. Application Data
(60) Provisional application No. 62/896,570, filed on Sep. 5, 2019.

(51) Int. Cl. G07F 11/16; G07F 17/00

(52) U.S. Cl. CPC G07F 11/16; G07F 17/0064

(57) ABSTRACT

The present technology is directed to a kiosk for storing, displaying, and distributing a plurality of baked products. The kiosk may include, for example, a housing defining a chamber therein and configured to receive a plurality of baked products. The kiosk may include one or more sensors configured to analyze the individual baked products to determine one or more baked unit parameters and adjust one or more baking inputs based on the measured parameters.

### CROSS-REFERENCE TO RELATED APPLICATIONS

The present application claims the benefit of priority to U.S. Provisional Patent Application No. 62/896,570, filed Sep. 5, 2019, the entirety of which is incorporated by reference herein.

The present application incorporates by reference herein PCT Application No. PCT/IB19/000211, filed Mar. 1, 2019, in its entirety.

### TECHNICAL FIELD

Embodiments of the present technology are directed to kiosks for providing and distributing baked product, such as bread, and associated systems and methods.

### BACKGROUND

Currently customers purchase bread and other baked products from the shelves of a local supermarket. Because baked products have a limited shelf-life (as compared to other food products available on the shelves) and is centrally produced, the available baked products frequently contain preservatives and are formulated for improved transport and storage rather than freshness, nutrition, flavor, and customer taste preferences. Centrally produced baked goods require a high amount of manual labor for delivery and presentation such as shipping and receiving, stacking the product on the shelves, organizing the product by brand and/or type of bread, etc. Moreover, the customer is faced with a limited number of options, all of which have been pre-selected by the supermarket. Accordingly, there is a need for an improved system for providing baked goods to customers.

### SUMMARY

The present technology is directed to automated production systems and associated processes, and, more particularly, to an automated bread making system and associated processes. The subject technology is illustrated, for example, according to various aspects described below, including with reference to FIGS. 1A-11B. Various examples of aspects of the subject technology are described as numbered clauses (1, 2, 3, etc.) for convenience. These are provided as examples and do not limit the subject technology.
1. A kiosk for storing, displaying, and distributing a plurality of baked units, the kiosk comprising:
   a housing defining a chamber therein;
   a transition assembly positioned at least partially within the chamber and configured to support one or more of the baked units;
   a carrier configured to move horizontally and vertically within the chamber, the carrier being configured to receive and carry one or more of the baked units;
   one or more sensing elements configured to obtain data associated with one or more of the baked units along the production path, then data comprising baked unit parameters including one or more of a height, a color, a surface topography, a temperature, a volume, and/or a shape of the individual baked units;
   a plurality of racks disposed within the chamber and individually configured to support one or more of the baked units;
   a controller coupled to the carrier and the sensors, the controller comprising tangible, non-transitory, computer-readable media storing instructions executable by the processor to cause the kiosk to perform one, some, or all of the operations comprising:
   retract a portion of the transition assembly towards the baked unit,
   rotate the transition assembly and baked unit towards the carrier,
   move the carrier proximate the transition assembly to transfer the baked unit from the transition assembly,
   move the carrier away from the transition assembly to deliver the baked unit to one of the plurality of racks, and/or
   move the carrier to retrieve a particular baked unit from its rack and deliver the particular baked unit to the dispensing area.
2. The kiosk of Clause 1, further comprising a dispensing area within the chamber comprised of an actuator, a tray, and an opening in the chamber through which a customer may retrieve the particular baked unit.
3. The kiosk of Clause 1 or Clause 2, wherein the carrier is moveable along vertical and horizontal tracks positioned within the chamber, and wherein the carrier includes an extender that is configured to extend and retract in a direction generally orthogonal to the vertical and horizontal tracks.
4. The kiosk of any one of Clauses 1 to 3, wherein the carrier includes an extender that is configured to extend away from the carrier towards one of the racks proximate the carrier to deliver a baked unit to the rack.
5. The kiosk of any one of Clauses 1 to 4, wherein the kiosk is a standalone kiosk.
6. The kiosk of any one of Clauses 1 to 5, wherein the housing surrounds the chamber such that an internal environment of the chamber is self-contained.
7. The kiosk of any one of Clauses 1 to 6, wherein the chamber has a controlled temperature.
8. The kiosk of any one of Clauses 1 to 7, wherein the chamber has a controlled pressure.
9. The kiosk of any one of Clauses 1 to 8, wherein the chamber has a controlled humidity.
10. The kiosk of any one of Clauses 1 to 9, wherein the kiosk is configured to be coupled to an adjacent kiosk, and wherein the adjacent kiosk provides the baked unit to the transition assembly of the kiosk.
11. The kiosk of any one of Clauses 1 to 10, wherein a side portion of the housing includes an opening through which the adjacent kiosk transfers the baked unit to the kiosk.
12. The kiosk of any one of Clauses 1 to 11, wherein the controller receives data from the one or more sensors characterizing one or more of the baked unit parameters and compares the data to a predetermined data set of baked unit parameters.
13. The kiosk of any one of Clauses 1 to 12, wherein at least one of the one or more sensors is an imaging device coupled to the controller and configured to send image data of the baked units to the controller for processing.
14. The kiosk of any one of Clauses 1 to 13, wherein the controller determines at least one of the baked unit parameters based on the image data.
15. The kiosk of any one of Clauses 1 to 14, wherein the transition assembly is a first transition assembly and the kiosk further comprises a second transition assembly positioned within the chamber and configured to receive and support a baked unit.
16. The kiosk of any one of Clauses 1 to 15, wherein the second receiving element delivers the baked unit to the first receiving element by rotating about a joint to expel the baked unit in the direction of the first receiving element.
17. The kiosk of any one of Clauses 1 to 16, wherein the baked unit is a loaf of bread.
18. The kiosk of any one of Clauses 1 to 17, wherein the racks extend into the chamber from an inner sidewall of the chamber.
19. The kiosk of any one of Clauses 1 to 18, wherein the racks are bread pans.
20. The kiosk of any one of Clauses 1 to 19, wherein the racks are arranged in a grid such that an individual rack corresponds to a location representing the intersection of a particular row and a particular column.
21. The kiosk of any one of Clauses 1 to 20, wherein the controller is configured to monitor the inventory of the baked units via the one or more sensors and communicate the inventory data to a remote server and/or a remote database.
22. The kiosk of any one of Clauses 1 to 21, wherein the kiosk is wirelessly coupled to a remote server.
23. The kiosk of any one of Clauses 1 to 22, wherein the controller moves the carrier to retrieve a particular baked unit from its rack in response to a customer request for the particular baked unit received from a remote server and/or an input device integrated with housing.
24. The kiosk of any one of Clauses 1 to 23, further comprising an input device at an exterior portion of the housing, wherein the input device is coupled to the controller and configured to receive input from a customer.
25. The kiosk of any one of Clauses 1 to 24, wherein the user interface includes a touch screen.
26. The kiosk of any one of Clauses 1 to 25, wherein, in response to a request for a particular baked unit made via the input device, the controller moves the carrier to retrieve the particular baked unit within the chamber and deliver the particular baked unit to an opening in the housing.
27. The kiosk of any one of Clauses 1 to 26, wherein the input device communicates to the customer which of the baked units in the racks are the warmest.
28. The kiosk of any one of Clauses 1 to 27, wherein the input device communicates to the customer the different types of baked units within the chamber and enables the customer to select a particular one of the displayed baked units.
29. The kiosk of any one of Clauses 1 to 28, further comprising a device configured to slice the baked units.
30. The kiosk of any one of Clauses 1 to 29, further comprising a device configured to bag one or more of the baked units.
31. The kiosk of any one of Clauses 1 to 30, wherein the controller is configured to detect if a baked unit has been handled by a customer and, in response to such detected handling, discard the handled baked units.
32. The kiosk of any one of Clauses 1 to 31, wherein the controller automatically selects a baked unit that is the warmest.
33. The kiosk of any one of Clauses 1 to 32, further comprising a means for tagging and tracking individual racks and/or individual baked units.
34. The kiosk of any one of Clauses 1 to 33, wherein the tagging includes associating one or more of the baked unit parameters with a particular baked unit.
35. The kiosk of any one of Clauses 1 to 34, wherein the controller is configured to wirelessly send and receive data from a mobile platform and/or mobile application.
36. A method for providing and distributing baked units, the method comprising:
   automatically receiving a baked unit into a receiving element positioned at least partially within a chamber of a kiosk;
   automatically moving the baked unit from the receiving element to an empty rack via a carrier configured to move horizontally and vertically within the chamber; and
   in response to receiving a request for a particular baked unit, moving the carrier to retrieve the particular baked unit and delivering the particular baked unit to a repository in the kiosk through which a customer may retrieve the particular baked unit.
37. The method of Clause 36, wherein, in response to a baked unit carried by the carrier moving outside of a range of a sensor, counting a number of increments moved by the carrier before leaving the range of the sensor.
38. The method of Clause 37, further comprising calculating the height of the baked unit based on the number of increments.
39. The method of Clause 36, wherein receiving the baked unit includes receiving the baked unit from a user.
40. The method of Clause 36, wherein receiving the baked unit includes receiving the baked unit automatically from an oven.
41. The method of Clause 40, wherein the kiosk is a first kiosk and the oven is integrated with a second kiosk.
42. The method of Clause 36, wherein receiving the baked unit from the second kiosk includes receiving the baked unit from an oven of the second kiosk.
43. The method of Clause 36, wherein the baked unit is a loaf of bread.
44. The method of Clause 36, wherein the baked unit is a first baked unit and receiving the first baked unit from the second kiosk occurs at a first time, and wherein the method further includes receiving a second baked unit from the second kiosk at a time.
45. The method of Clause 44, wherein the first baked unit is a first loaf of bread and the second baked unit is a second loaf of bread that is a different type of bread than the first loaf of bread.
46. The method of Clause 44, wherein the first baked unit is a first loaf of bread and the second baked unit is a second loaf of bread that is a size than the first loaf of bread.
47. The method of Clause 44, wherein the second time is within six minutes of the first time.
48. The method of Clause 44, wherein the second time is within five minutes of the first time.
49. The method of Clause 44, wherein the second time is within four minutes of the first time.
50. The method of Clause 44, wherein the second time is within three minutes of the first time.
51. The method of Clause 44, wherein the second time is within two minutes of the first time.
52. The method of Clause 44, wherein the second time is within one minute of the first time.
53. The method of Clause 44, wherein the time between automatically receiving the baked unit into the receiving element and when the controller displays the baked unit for selection by a customer is 30 seconds or less.
54. A system for producing, storing, displaying, and distributing a plurality of baked units, the system comprising:
   a production portion configured; and
   the kiosk of any one of Clauses 1-35.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIGS. 1A and 1B are front and isometric views, respectively, showing a system for the automated production and distribution of baked goods in accordance with the present technology.

FIG. 2A is a front view of a kiosk for use with the automated systems of the present technology.

FIGS. 2B and 2C are isometric views of a kiosk with a transition assembly in first and second positions, respectively, in accordance with the present technology. In FIGS. 2B and 2C, various portions of the housing have been removed to show the interior of the kiosk.

FIGS. 3A-3C are isolated views of the transition assembly shown in FIGS. 2B and 2C in different positions in accordance with the present technology.

FIGS. 4A-4G illustrate an example method for receiving a baked product at a transition assembly of the present technology.

FIG. 5A is an isometric view of a kiosk including a sensing element configured in accordance with the present technology. In FIG. 5A, various portions of the housing have been removed to show the interior of the kiosk.

FIGS. 5B and 5C are different views of a sensing element configured in accordance with the present technology.

FIGS. 5D and 5E are schematic representations of an example method of using a sensing element in accordance with the present technology.

FIGS. 6A and 6B are isometric views of a kiosk with a transition assembly in first and second positions, respectively, in accordance with the present technology. In FIGS. 6A and 6B, various portions of the housing have been removed to show the interior of the kiosk.

FIG. 6C is a partially isolated view of the transition assembly shown in FIGS. 6A and 6B.

FIGS. 7A-7E illustrate an example method for receiving a baked product at a transition assembly in accordance with the present technology.

FIG. 8 is an isolated view of a support assembly of a carrier system configured in accordance with the present technology.

FIGS. 9A and 9B are isolated views of a dispensing assembly in accordance with the present technology, shown with a customer tray in a retracted position and an extended position, respectively.

FIG. 10 is a flow chart showing an example system and production path in accordance with the present technology.

FIGS. 11A and 11B are front views of an automated system including one or more finishing units in accordance with the present technology.

### DETAILED DESCRIPTION

### I. Overview of Example Automated Production Systems

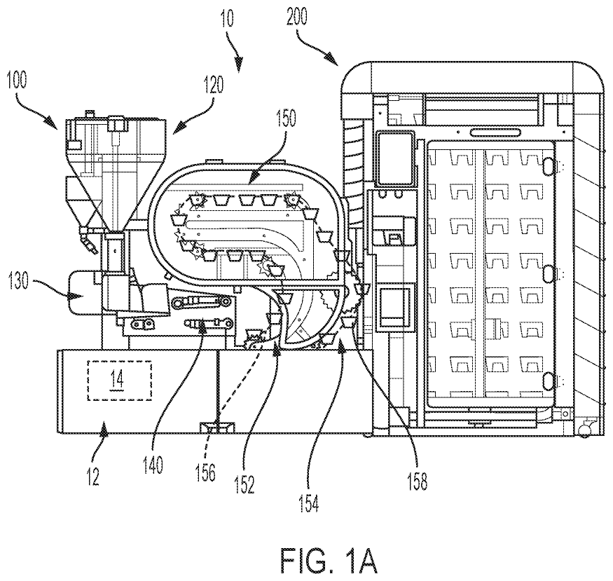

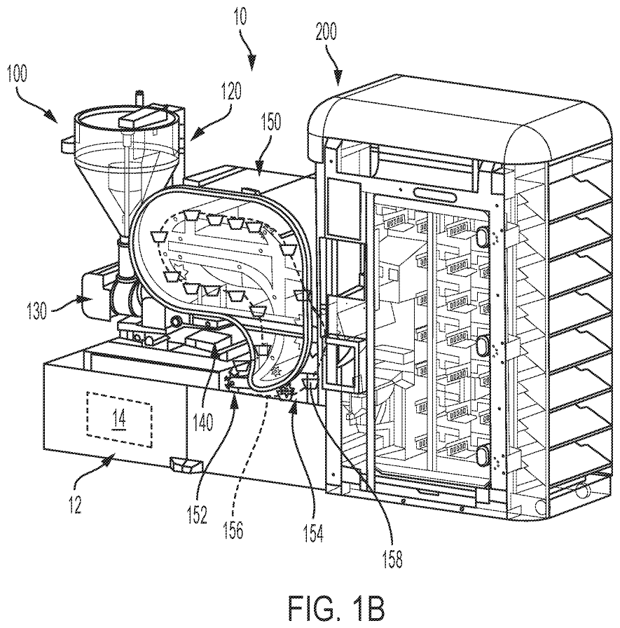

FIGS. 1A and 1B illustrate an automated system 10 for producing and distributing a baked product in accordance with one or more embodiments of the present technology. The baked product may include, for example, a loaf of bread, sub rolls, dinner rolls, artisan bread, breadsticks, cake, cupcakes, and other baked goods. As shown in FIGS. 1A and 1B, the system 10 may include a production portion 100 configured to make the baked product and a kiosk 200 configured to receive the baked product from the production portion 100 and store, display, manage, and distribute the baked product, as described in more detail herein.

The production portion 100 may comprise a priming assembly 120, a mixing assembly 130, a forming assembly 140, and an oven 150. The production portion 100 (or one or more assemblies thereof) and the kiosk 200 may be supported by or otherwise coupled to a frame 12. The production portion 100 may be configured to automatically and continuously move production ingredients (e.g., wet and dry ingredients) sequentially through the priming assembly 120, the mixing assembly 130, the forming assembly 140, and the oven 150 to produce a baked product. The priming assembly 120, for example, may be configured to receive, mix, and/or measure the ingredients separately before delivering the wet and dry ingredients to the mixing assembly 130. The amount of wet and dry ingredients may represent an individual unit of a baked product, for example a single loaf of bread, a single cupcake, etc. In some embodiments, the amount of ingredients may represent a plurality of units of a baked product, for example, a plurality of loaves of broad, a plurality of rolls, a plurality of cupcakes, etc. The mixing assembly 130 may be configured to mix the wet and dry ingredients together to form a lump of dough or batter, and deliver the lump of dough to the forming assembly 140. The forming assembly 140 may be configured to shape the lump of dough in preparation for baking, to provide time for resting and proving of the dough, and may then deliver the shaped lump of dough to the oven 150 where the shaped lump of dough is baked into the final baked product (e.g., such as a loaf of bread).

The system 10 can further include one or more controllers 14 (one shown schematically in FIGS. 1A and 1B), each having memory and processing circuitry. In some embodiments, the system 10 may include a first controller carried by the production portion 100, and a second, separate controller carried by the kiosk 200. In some embodiments, the system 10 includes a single controller that monitors and controls both the production portion 100 and the kiosk 200. The one or more controllers 14 of the system 10 may be coupled to and in communication with a remote server (not shown) and/or other systems 10 via a local area network (“LAN”) and/or a wide area network (“WAN”). In some embodiments, the controller 14 may be a remote computing device (e.g., a remote server), and in some embodiments, the controller 14 may comprise both a local computing device carried by the production portion 100 and/or kiosk 200 and a remote computing device. As described in greater detail below, the one or more controllers may monitor various conditions at the kiosk 200 and provide feedback to other systems 10 or the production portion 100 to affect the type of baked product, the size of the baked product, the type of ingredients and amount of ingredients of the baked product, and the timing of one or more of the assemblies.

As shown in FIGS. 1A and 1B, the priming assembly 120 may include a dry ingredients priming unit and a wet ingredients priming unit. The dry ingredients priming unit of the illustrated embodiment comprises a vertically-oriented, conical hopper 122 coupled to a drive system and a screw or auger (not visible) that extends vertically through the center of the hopper 122 and is configured to mix dry ingredients fed to the hopper 122. Additionally or alternatively, the hopper 122 may include other means for mixing the dry ingredients. In some embodiments, the priming assembly 120 may include multiple dry ingredients priming units and/or the dry ingredients priming unit may include multiple hoppers.

The one or more hoppers 122 of the dry ingredients priming unit may be configured to receive dry ingredients from one or more sources. For example, in some embodiments, the system 10 can include one or more containers (not shown) configured to house one or more dry ingredients and feed the ingredients to the hopper 122. The timing, amount, and type of ingredient may be controlled or adjusted based on feedback received from the kiosk 200 and/or from input received by a customer at the kiosk 200 or via the Internet (via the one or more controllers 14). The containers can be fixed to the frame 12 (or other component of the system 10) and/or operably coupled to the hopper(s) via tubing and/or one or more valves. In such embodiments, the controller 14 can be coupled to the valves to automatically control the timing, amount, and/or composition of ingredients dispensed into the hopper(s) 122 from the container(s). In other embodiments, the dry ingredients can be manually dispensed into the hopper(s) 122 from the external source(s). In some embodiments, the container(s) can be mounted to a rotatable table and the dry ingredients can be dispensed into the hopper(s) 122 by rotating the table to align an outlet of the container with an aperture in the table and an inlet of the hopper 122. The rotation of the table may be adjusted by the one or more controllers 14 or done manually. Additionally or alternatively, a knife gate valve may be placed at the inlet of hopper 122 to regulate the dispensing of the ingredients from the containers.

In some embodiments, the production portion 100 may include 1 to 60, 2 to 50, 20 to 30, at least 5, at least 10, at least 15, at least 20, at least 25, at least 30, or at least 50 hoppers and/or sources. The hoppers and/or sources may be conical and/or cubical, and/or whatever shape is most space-efficient for the application. Any of the hoppers and/or sources may include a mixing and/or agitating means.

Referring still to FIGS. 1A and 1B, the oven 150 may comprise an inlet 152, an outlet 154, and a belt 156 extending between the inlet 152 and the outlet 154. The belt 156 may be carried and directed by a series of supports (e.g., sprockets) and configured to transport baking pans 158 (e.g., non-stick baking pans) through the oven 150 along a baking path from the inlet 152 to the outlet 154. The pans 158 may be located at spaced intervals along the belt 156. In some embodiments, each of the pans 158 sit in a frame (not shown), and the frame is coupled at both longitudinal ends to the belt 156. In some embodiments, the frame is coupled at both longitudinal ends to the belt 156 such that the frame (and pan 158 and baked product within) can rotate about the attachment points to the belt 156.

Additional examples of production portions 100 and components thereof for use with the kiosks 200 disclosed herein may found at, for example, U.S. Pat. No. 8,091,471, filed Apr. 13, 2006, and U.S. patent application Ser. No. 15/753,261, filed Feb. 17, 2018, both of which are incorporated herein by reference in their entireties.

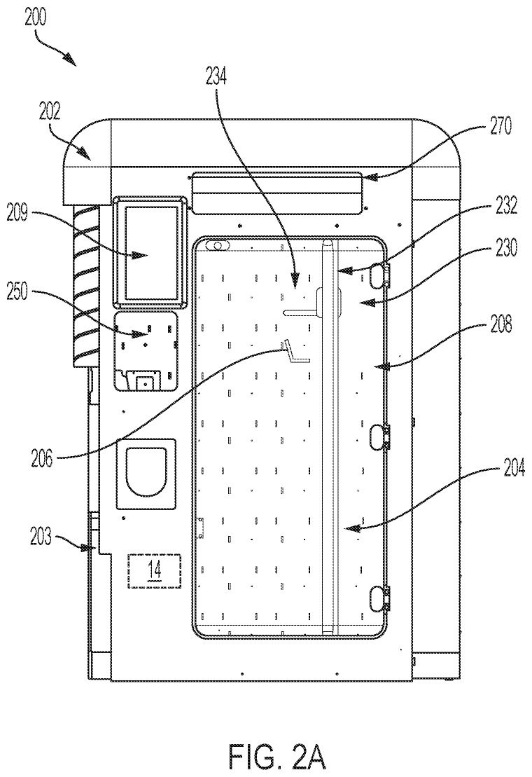

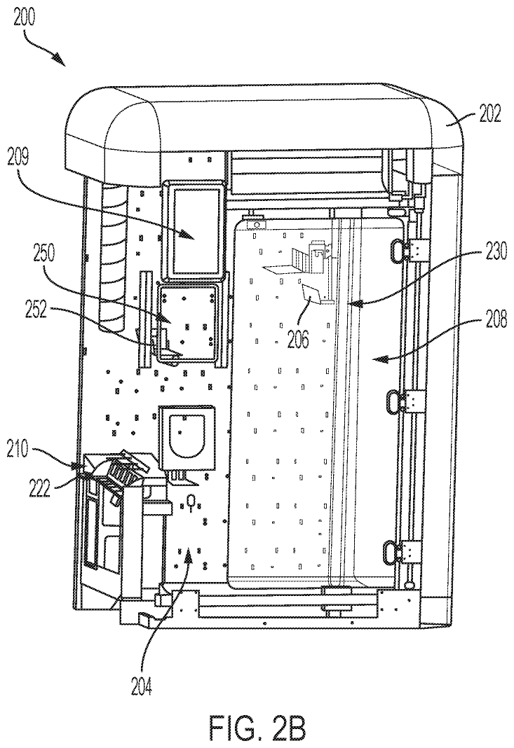

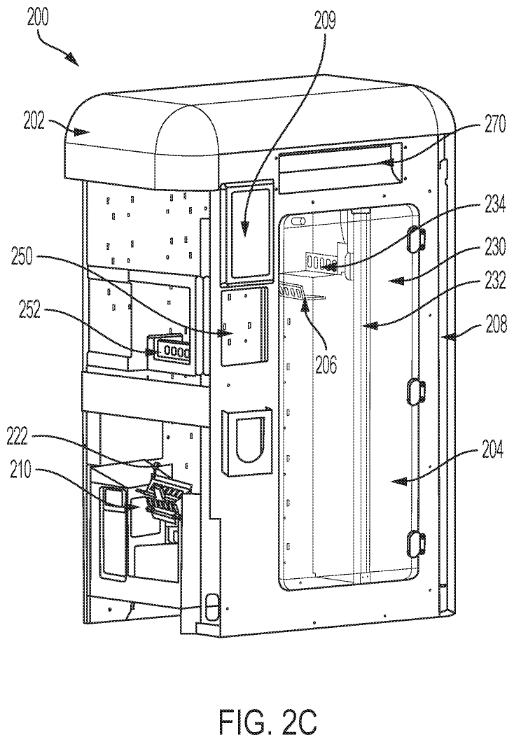

FIGS. 2A and 2B are front and isometric views, respectively, of the kiosk 200, shown isolated from the system 10. In FIG. 2B, various portions of the housing of the kiosk have been removed to show the interior of the kiosk 200. The kiosk 200 may include a housing 202 defining a chamber 204 therein that is configured to hold a plurality of racks 206. While FIGS. 1A and 1B show a plurality of racks 206 within the chamber 204, only one rack 206 is shown in FIGS. 2A and 2B for ease of viewing other features of the kiosk 200. As detailed below, the kiosk 200 may include a transition assembly 210 (only visible in FIG. 2B) for receiving the baked product from the production portion 100, a carrier system 230 configured to receive the baked product from the transition assembly 210 and manipulate and/or transport the baked product within the chamber 204, and a dispensing assembly 250 for facilitating transfer of the baked product from the chamber 204 to the customer.

The chamber 204 may be configured to temporarily store individual units of a baked product made by the production portion 100 of the system 10, either individually or in a batch. As used herein, the term “individual unit” or “individual baked unit” may refer to an amount of a baked product that is typically offered for sale in a grocery or bakery setting. This may include a single baked product or a plurality of discrete baked products. For example, “individual unit” may refer to a single loaf of bread, a single cake, a single cupcake, a single cookie, a single donut, etc., or may refer to a plurality of cupcakes, a plurality of cookies, a plurality of donuts, etc. (e.g., four, six, eight, a dozen, etc.) typically offered for sale in a grocery setting. The chamber 204 may be configured to store configured to store 10 or more, 20 or more, 30 or more, 40 or more, 50 or more, 75 or more, or 100 or more individual units.

The kiosk 200 may be configured such that various parameters associated with the internal environment of the chamber 204 may be monitored and adjusted by the user as necessary to maintain the freshness of the baked product. Such parameters may include temperature, pressure, humidity, and others. The chamber 204 may be configured to store a baked product, for example, for at least 6 hours, at least 8 hours, at least 12 hours, at least 18 hours, at least 24 hours, at least 36 hours, at least 48 hours, at least 72 hours, at least 4 days, at least 5 days, at least 6 days, or at least 7 days.

The chamber 204 may be completed enclosed by the housing 202, or the chamber 204 may be only partially enclosed by the housing 202. For example, the chamber 204 may have openings through which the chamber 204 is exposed to an external environment and/or the production portion 100. In the example embodiment depicted in FIGS. 2A and 2B, the housing 202 includes an opening 203 (best depicted in FIG. 2A) at the side of the kiosk 200 configured to be positioned adjacent the production portion 100. In various aspects of the technology, the housing 202 includes a door 208 that opens to the chamber 204. As shown, all or a portion of the door 208 may be transparent such that the chamber's contents (including the baked product) are visible to a customer at the exterior of the kiosk 200. In some embodiments, the door 208 is solid such that the contents are not visible through the door 208 from an exterior of the kiosk 200.

As previously mentioned, the kiosk 200 may include a plurality of racks 206 positioned within the chamber 204. Each of the plurality of racks 206 may be configured to hold an individual baked unit. The individual racks 206 may comprise a tray, a shelf, or other suitable surface for receiving and supporting the baked product. Each of the racks 206 may have a generally L-shape, with the lower support surface of the rack 206 comprising a plurality of teeth or fingers spaced apart from one another. The individual racks 206 may be configured to support the baked product and its associated container (such as a baking pan or sheet) as well as the baked product free of any container or other holding device. The racks 206 may be stationary, rotatable, or moveable relative to one another and/or relative to the chamber 204. Individual racks 206 may be configured to rotate or move individually and/or in groups. In some embodiments the racks 206 may be mounted on a track or conveyor configured to move and adjust the relative position of the racks 206 within the housing. According to various aspects of the technology, the size, shape, and relative position of the racks 206 may be modified to match or be proportional to the baked product in production (and its associated container, if applicable). For example, relatively large racks may be used for individual loaves of bread, while relatively small racks may be used for individual cupcakes. In some embodiments the racks 206 may be mounted on a track or conveyor configured to move and adjust the relative positions of the racks 206 within the housing 202.

The transition assembly 210 may be configured to receive the baked product from a source (such as the oven 150 or other portion of the production portion 100) and transfer or facilitate transfer of the baked product to the carrier system 230 for handling of the baked product within the chamber 204. As shown in FIGS. 2B and 2C, the transition assembly 210 may be positioned within the chamber 204 proximate the opening 203 in the housing 202 aligned with the oven outlet 154. In some embodiments, the transition assembly 210 may be moveable relative to the chamber 204 and/or the housing 202 to facilitate transfer of the baked product from the oven 150 to the chamber 204. As detailed below, the transition assembly 210 may be configured to move at least between a first position in which the transition assembly 210 receives the baked product (as shown in FIG. 2B) and a second position in which the transition assembly 210 is in an orientation that facilitates transfer of the baked product to the carrier system 230 (as shown in FIG. 2C). In some embodiments, the kiosk 200 does not include a transition assembly 210 and the baked product is delivered from the production portion 100 directly to the carrier system 230. Moreover, in those embodiments where the kiosk 200 is a standalone device, a user may manually feed or stock the baked product to the transition assembly 210, the carrier system 230, and/or racks 206 of the kiosk 200.

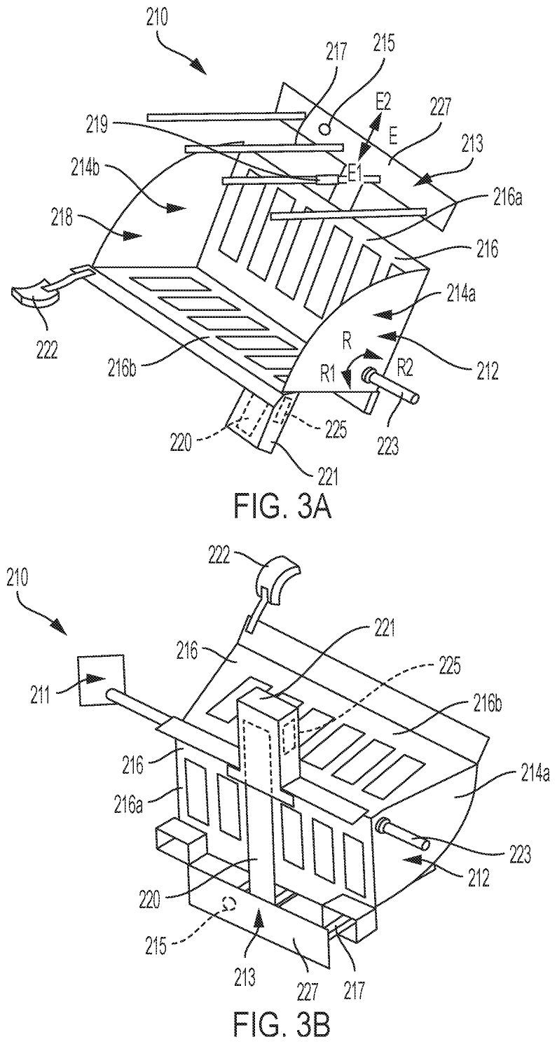

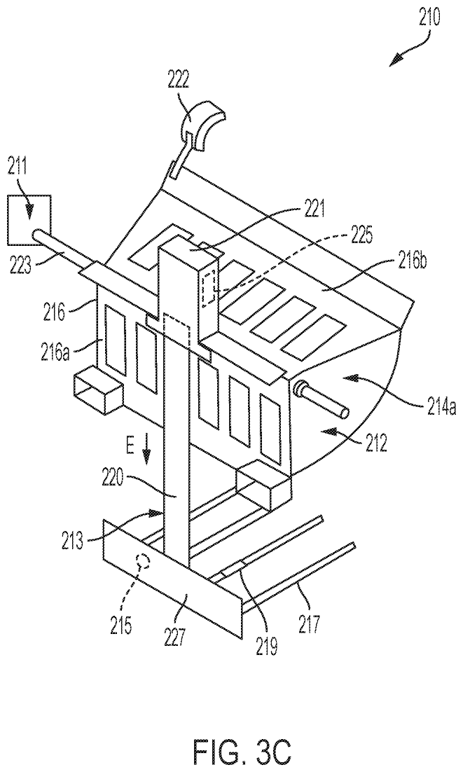

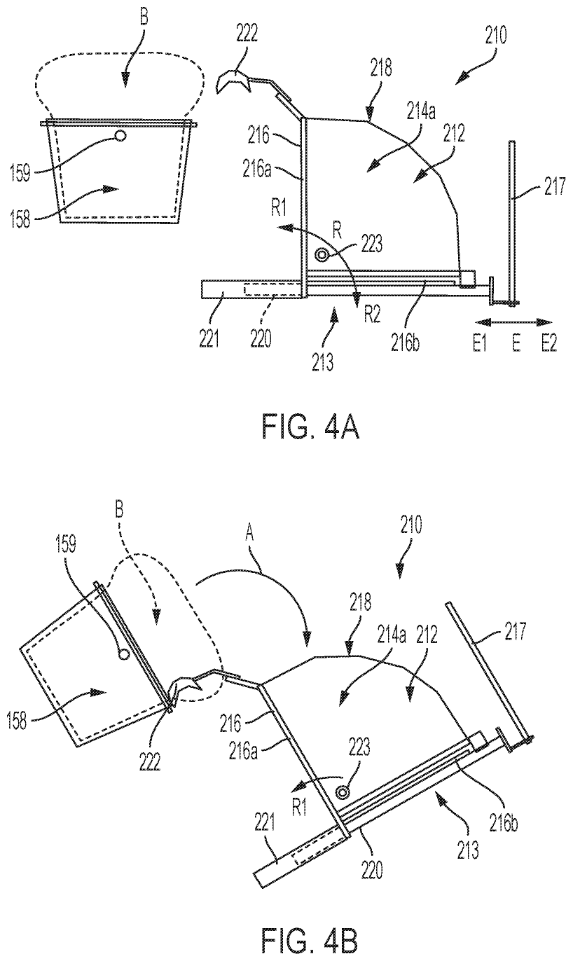

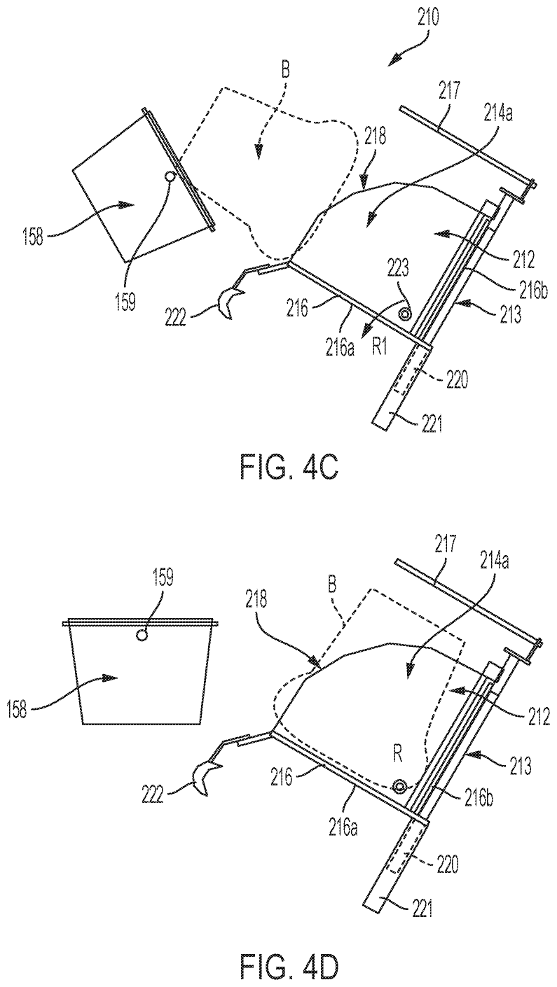

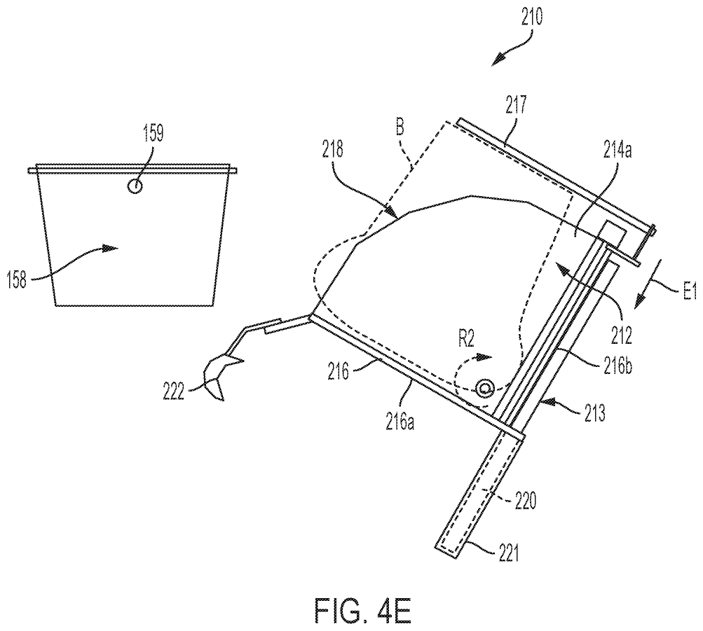

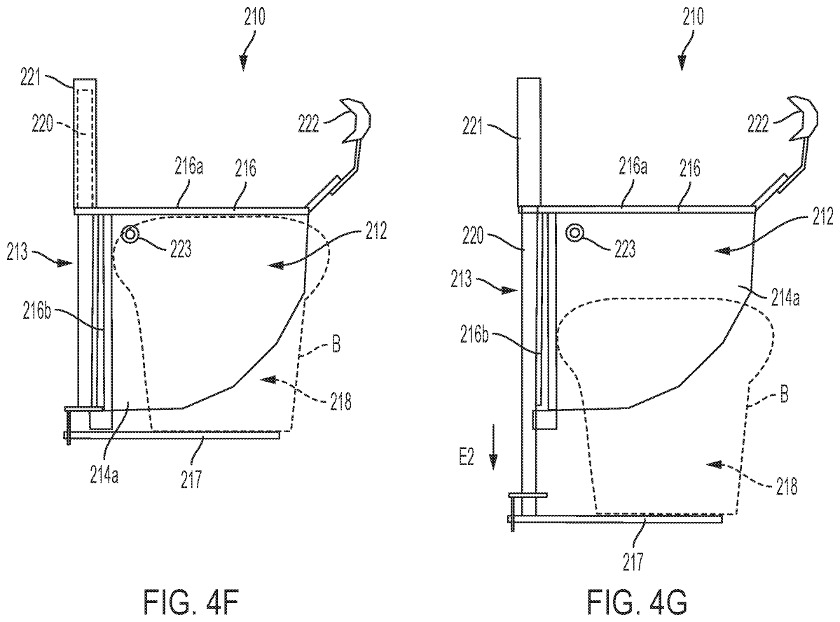

FIGS. 3A-3C are enlarged views of the transition assembly 210 isolated from the kiosk 200 and shown in different positions. As shown in FIGS. 3A-3C, the transition assembly 210 may comprise a receptacle 212, a retainer 213 moveably coupled to the receptacle 212, and a coupling element 223 that moveably couples the transition assembly 210 to the housing 202. The coupling element 223 may be coupled to an actuator 211 (shown schematically in FIG. 3B) at or supported by the housing 202. The transition assembly 210 may optionally include an engagement element 222 for initiating and/or expediting the dispensing of the baked product from an adjacent oven pan 158 (or other source of baked product) to the transition assembly 210, as described in greater detail below with respect to FIGS. 4A-4G.

As indicated by arrow R in FIG. 3A, the transition assembly 210 may be configured to rotate about its long axis via the coupling element 223. For example, the coupling element 223 may be coupled to an actuator (not shown) and/or the controller 14 such that the controller 14 may cause rotation of the coupling element 223 in a first direction R1 and a second direction R2 opposite the first direction R1, thereby also causing the transition assembly 210 to rotate in the first direction R1 and the second direction R2. Rotation of the transition assembly 210 may be driven by an electric motor, an air powered drive, or hydraulically driven. At any time while the transition assembly 210 is rotating or stationary, the retainer arm 220 may extend E2 or retract E1.

The receptacle 212 may comprise an elongated, v-shaped base portion 216 comprising first and second surfaces 216a and 216b, and the base portion 216 may extend between first and second sidewalls 214a and 214b (referred to together as “sidewalls 214”). Together the base portion 216 and the sidewalls 214 may define an interior region 218 configured to receive and support a baked product. In some embodiments, The base portion 216 may include a plurality of slits or openings that allow the freshly baked product to continue to cool. In some embodiments, the base portion 216 does not include any slits or openings and instead comprises a continuous surface. The receptacle 212 may be sized to have a length, width, and/or height slightly larger than the length, width, and/or height of the baked product and/or the pans 158 such that the transition assembly 210 can receive the baked product directly when the baked product is dispensed from the pan 158.

The retainer 213 of the transition assembly 210 may comprise an arm 220 having a lateral extension 227 at its distal region and moveably coupled to the receptacle 212 (e.g., the base portion 216) at its proximal region. The retainer 213 may further include fingers 217 coupled to the extension 227 and extending away from the arm 220 at an angle relative to the long axis of the arm 220. In some embodiments, the fingers 217 may be angled between about 30 and 90 degrees relative to the arm 220, or between about 45 and 90 degrees, between about 60 and 90 degrees, between about 75 and 90 degrees, or about 90 degrees. The fingers 217 may be spaced apart from one another along the long axis of the extension 227 with gaps between adjacent fingers 217. The individual fingers 217 may be spaced apart at a distance sufficient to receive the fingers of the carrier system 230, but close enough that the fingers 217 can support a baked product. Moreover, the individual fingers 217 may have a length and a cross-sectional area configured to support a baked product.

The arm 220 of the retainer 213 may be slidably coupled to the receptacle 212 and configured to extend and retract relative to the receptacle 212, as indicated in FIG. 3A by arrow E. A proximal region of the arm 220 may be coupled to an actuator 225 (shown schematically). In some embodiments, the arm 220 extends generally parallel with the adjacent surface 216a of the base portion 216. In some embodiments, the arm 220 may extend and retract at an angle relative to the adjacent surface 216a of the base portion 216. In any case, the fingers 217 may extend away from the arm 220 and into the interior region 218 (FIG. 3A) such that the fingers 217 effectively form an additional sidewall (along with the base portion 216 and the sidewalls 214) to the interior region 218.

In some embodiments, such as that shown in FIG. 3A, the actuator 225 may be enclosed within a housing 221. In some embodiments, the proximal region of the arm 220 and/or the actuator 225 are not contained within a housing.

The actuator 225 may be coupled to the controller 14 such that the controller 14 can cause the arm 220 to extend and retract, thereby moving the fingers 217 farther and closer to the receptacle 212, respectively, and altering the dimensions of the interior region 218. FIG. 3B shows the arm 220 in a fully retracted position, and FIG. 3C shows the arm 220 in a fully extended position. Such a feature may be beneficial for adjusting the receiving and holding capacity of the receptacle 212 based on the size of the baked product. In some embodiments, the distance moved by the arm 220 relative to the receptacle 212 may be preset based on the baked product in production. In some embodiments, the distance traveled by the arm 220 may be set such that in the extended position the interior region 218 is slightly larger than the baked product and in the retracted positioned the interior region 218 is slightly smaller than the baked product.

In some aspects of the present technology, the transition assembly 210 may include one or more sensing elements configured to obtain data related to the position of the baked product relative to the transition assembly 210. For example, as shown in FIGS. 3A-3C, the retainer 213 may include a sensing element 215 configured to determine whether the baked product is within a predetermined distance of the lateral extension 227 and/or adjacent portions of the arm 220 and/or base portion surface 216a. The sensing element 215 may be coupled to the controller 14 and configured to notify the controller 14 when the sensing element 215 detects and does not detect the presence of the baked product within its predetermined detection range. As described in greater detail below, such a feature may be beneficial during transfer of the baked product from the transition assembly 210 to the carrier system 230, as the sensing element 215 can alert the controller 14 when the support assembly 234 of the carrier system 230 has moved the baked product outside of the footprint of the transition assembly 210. The controller 14 can then cause the carrier support assembly 234 (and associated baked product) to move the baked product to its designated rack 206 without the transition assembly 210 jostling or knocking the baked product off the carrier support assembly 234. In some embodiments, for example, the sensing element 215 may include one or more optical sensors, such as one or more photoelectric sensors. In some embodiments, the sensing element 215 may include one or more pressure sensors.

Additionally or alternatively, one or more of the fingers 217 may include one or more sensing elements. For example, one or more of the fingers 217 may include a sensing element 219 (only shown in FIGS. 3A and 3C) configured to detect the presence of the baked product on the fingers 217. The sensing element 219 may include, for example, one or more pressure sensors. In some embodiments, for example, the sensing element 219 may include one or more optical sensors, such as one or more photoelectric sensors.

It will be appreciated that, for any of the sensing elements described herein, a single sensing element may be included in the drawings for clarity, even though in various embodiments the system 10 may include a plurality of such sensing elements. As used herein, the term “sensing element” may refer to a single sensor or a plurality of discrete, separate sensors.

FIGS. 4A-4G schematically illustrate an example method of operating a transition assembly 210 of the present technology, such as the transition assembly 210 shown in FIGS. 2A-3C. At random or predetermined time intervals (e.g., every minute, every two minutes, every three minutes, every four minutes, every five minutes, every six minutes, every seven minutes, every eight minutes, etc.) a baked product B may arrive at the oven outlet 154 of the production portion 100 (see FIGS. 1A and 1B), positioned in a baking pan 158. In some embodiments, the baking pans 158 may be coupled to the oven belt 156 (see FIGS. 1A and 1B) such that the pans 158 may rotate about their long axis. For example, the individual pans 158 may be coupled to the belt 156 via pins or connectors 159 (see FIGS. 4A-G), about which the pan 158 may rotate. In some embodiments, the pans 158 may additionally or alternatively be configured to rotate about their short axis.

In order to transfer the baked product B (depicted schematically as a loaf of bread in FIG. 4A) to the transition assembly 210, the system 10 may be configured to dump the baked product B from the pan 158 onto a receiving element of the kiosk 200 (such as the transition assembly 210 or the carrier system 230). In some embodiments, the transition assembly 210 may facilitate the dispensing of the baked product B. For example, as shown in FIG. 4B, the transition assembly 210 may be rotated in the first direction R1 (towards the baking pan 158), which causes the engagement element 222 to rotate into contact with the pan 158. The engagement element 222 may be configured to engage a top, body, or bottom portion of the pan 158, or may be configured to engage the pan 158 indirectly by contacting a frame that couples the pan 158 to the oven belt 156.

As the transition assembly 210 continues to rotate in the first direction R1, the engagement element 222 may push or pull the top edge of the pan 158 downwards, causing the pan 158 to rotate about the connector 159 towards the kiosk 200 (e.g., the transition assembly 210), as indicated by arrow A in FIG. 4B. As such, rotation of the transition assembly 210 in a first direction causes rotation of the pan 158 in the opposite second direction. In some embodiments, the pan 158 may start (e.g., before contact with the engagement element 222) in a slightly rotated position such that a top surface of the pan is angled towards the transition assembly 210. In some embodiments, the pan 158 may start at a generally level position.

In some embodiments, the engagement element 222 may have a rounded distal surface, or may have other suitable shapes and configurations. The rounded distal surface may be beneficial for continuously, evenly pushing the pan 158 while the pan 158 rotates.

As shown in FIG. 4C, the transition assembly 210 may stop rotating and remain stationary in a first or receiving position. In this first position, the engagement element 222 may be spaced apart from the pan 158 (as shown in FIG. 4C) (e.g., such that the engagement element 222 is not contacting the pan 158), or the engagement element 222 may remain in contact with the pan 158 in the first position. In some embodiments, the engagement element 222 remains in contact with the pan 158 while at least a portion of the baked product is transferred. Rotation of the pan 158 towards the transition assembly 210 causes the baked product to fall, slide, or otherwise be ejected from the pan 158. The transition assembly 210 may be configured to rotate a predetermined distance and speed such that rotation of the transition assembly 210 in the first direction rotates the pan 158 and aligns the interior region 218 of the transition assembly 210 with the trajectory of the baked product B as it leaves the pan 158. In some embodiments, the baked product B may rotate even after leaving the pan 158 such that a top region of the baked product B lands adjacent the first surface 216a of the base portion 216, as shown in FIG. 4D. In some embodiments, the baked product B may not continue to rotate after being dispensed and instead may enter the interior region 218 sideways and slide along the first surface 216a of the base portion 216 such that a top region of the baked product B is adjacent the second surface 216b of the base portion 216.

In those embodiments where the transition assembly 210, receptacle 212, and/or retainer 213 includes a sensing element configured to confirm the presence of the baked product B in or at the interior region 218 of the transition assembly 210 (such as sensing element 219 in FIGS. 3A and 3C), confirmation of this presence may cause the controller 14 to retract the arm 220 (as indicated by arrow El in FIG. 4E) to bring the fingers 217 into firm contact with the baked product B. In some embodiments, the retraction distance of the arm 220 is predetermined based on the expected size of the baked product B. In some embodiments, the retraction distance may be determined in real time to accommodate a range of sizes of baked products B. For example, the transition assembly 210 may include a sensor (not shown), such as a photoelectric, pressure, or torque sensor, configured to provide feedback to the controller 14 that the baked product is firmly retained within the transition assembly 210. Once the controller 14 receives data that the baked product is firmly retained, the controller 14 may cause the actuator 225 (not shown) to cease movement of the arm 220.

With the baked product in the transition assembly 210, the controller 14 may cause the transition assembly 210 to rotate in a second direction R2 (FIG. 4E) away from the pan 158, towards the chamber 204 of the kiosk 200 and into a second or offloading position (as shown in FIG. 4F). The transition assembly 210 may continue to rotate in the second direction until the baked product is upward facing and resting on the fingers 217. In some embodiments, the arm 220 may be extended to increase the bound volume of the interior region 218 such that the weight of the baked product rests on the fingers 217.

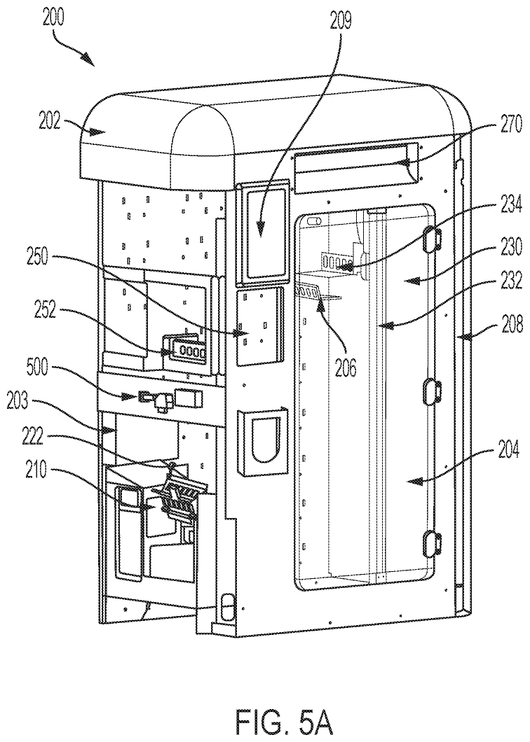

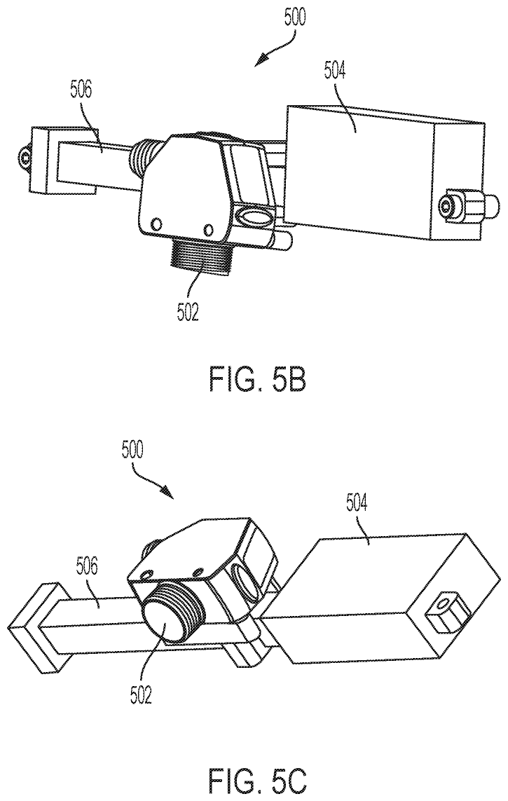

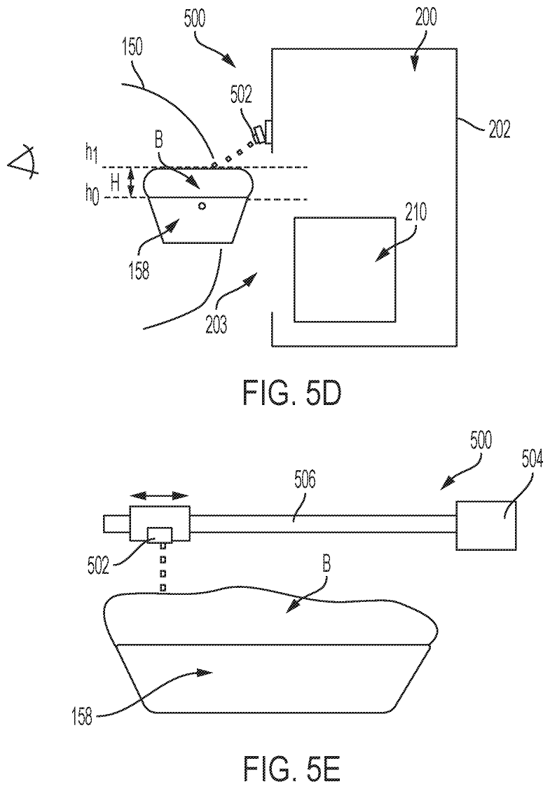

In some embodiments, the kiosk 200 may optionally include one or more sensing elements configured to obtain measurements of the baked product before, during, and/or after transfer of the baked product from the production portion 100 to the kiosk 200. FIG. 5A, for example, is an isometric view of a kiosk 200 including a sensing element 500 configured in accordance with the present technology. In FIG. 5A, various portions of the housing have been removed to show the interior of the kiosk 200. As shown in FIG. 5A, the kiosk 200 may include one or more sensors 500 proximate the oven outlet 154/kiosk 200 junction so that one or more parameters of the freshly baked product may be assessed before being made available (via the kiosk 200) to a customer. Measurements obtained by the sensing element 500, for example, may be used by the system 10 and/or kiosk 200 to describe the individual baked product to the customer (locally at the kiosk or remotely via a Web or mobile application), and also to provide feedback to one or more assemblies of the production portion 100. The sensing element 500 may be coupled to one or more computing devices, such as a local computing device (e.g., controller 14) and/or to a remote computing device (not shown). The sensing element 500 may transmit data associated with the baked product to the computing device for analysis. Based on the analysis, the controller 14 may display information to a customer or potential customer and/or may adjust one or more production parameters, as discussed in greater detail below.

FIGS. 5B and 5C are different views of the sensing element 500. The sensing element 500 may include a sensor 502 coupled to an actuator 504 and slidable along a track 506. The sensor 502 may be an optical sensor configured to measure a distance between the baked product and the sensor. For example, as shown schematically in FIGS. 5D and 5E, the sensing element 500 may be mounted to an exterior portion of the housing 202 above the opening 203 through which the baked product B passes between the oven 150 and the kiosk 200. In those embodiments where the pan 158 is positioned completely proximal of the plane of the opening 203 (and thus not aligned with or extending into the kiosk 200) immediately before or during transfer, the sensor 502 may be angled relative to the plane of the opening 203 so that the detection signal is directed at the baked product B, as shown in FIG. 5D. In some embodiments the sensor 502 may not be angled relative to the housing 202, for example when the pan 158 is positioned at least even with or partially through the plane of the opening 203. In some embodiments, the sensor 502 may be configured to rotate such that it can change positions relative to the housing 202 before or while scanning.

In some embodiments, the sensing element 500 may be affixed to the housing 202 such that the sensing element 500 is aligned with or proximal to the oven outlet 154, between the oven outlet 154 and the kiosk housing 202 (with or without overlapping with the oven outlet 154 and the kiosk 200 and/or transition assembly 210), and/or aligned with or distal to a proximal terminus of the transition assembly 210. In the embodiment shown in FIGS. 5A-5D, at least one sensor of the sensing element 500 is mounted at an exterior portion of the housing 202 above the opening 203. In some embodiments, the sensor 502 may be positioned at an interior portion of the housing 202 above the opening 203 and/or to the side of or below the opening 203 (at an exterior or interior location), and/or the sensing element 500 may include one or more additional sensors that are positioned at an interior portion of the housing 202 above the opening 203 and/or to the side of or below the opening 203 (at an exterior or interior location).

As previously mentioned, before, during, or after transfer of the baked product B from the oven to the transition assembly 210, one or more of the sensing elements of the system, including sensing element 500, may obtain one or more measurements of the baked product B and/or one or more environmental parameters. For example, in some embodiments the sensing element(s) (including sensing element 500) may obtain one or more baked product parameters, such as height, length, width, moisture content, uniformity, color, mass, moisture content, temperature at or near the baked product, shape, surface topography, age, chemical composition, and others, and/or the sensing element(s) (including sensing element 500) may obtain one or more environmental parameters, such as chamber 204 temperature, chamber 204 humidity, chamber 204 pressure, chamber 204 air composition, and others. The baked product parameters and/or the environmental parameters may be communicated to the controller 14 and, based on one, some, or all of the parameters, the controller 14 may adjust one or more of the baking inputs, such as ingredient mass and volume, ingredient type, water temperature, ambient temperature, moisture content of dough, mass of dough, oven temperature, mixing duration, proofing duration, baking duration, and others.

In some implementations, the sensor 502 may move along the track 506 and obtain height data along all or a portion of the length of the baked product B. The height data may include an elevation hi of a top surface of the baked product B. The elevation hi may be communicated from the sensing element 500 to the controller 14, and the controller 14 may compare the elevation hl to a predetermined reference elevation ho, such as the top of the pan 158. In some embodiments, the reference elevation may be a different location, such as the bottom of the pan 158. In any case, based on the measured elevation hi and the reference elevation ho, the controller 14 may determine a height H of the baked product B. The controller 14 may determine the height of the baked product B at every location along its length, and/or may determine an average height of the baked product B.

In some embodiments, the controller 14 may compare a maximum, minimum, and/or average height of the baked product to a corresponding, predetermined maximum, minimum, and/or average height threshold. Based on the comparison, the controller 14 may adjust one or more input parameters, such as amount of yeast, speed of mixing within the mixing assembly, amount of water added, oven and/or proofer temperature, speed at which the dough moves through the forming assembly, and others. In some embodiments, the controller 14 may provide an indication to an operator that the dry ingredients need to be replaced, or that a manual adjustment is required to one of the parameters. If the measured height H of a loaf of bread is too low, for instance, it may indicate that the bread is of poor quality. In response to detecting a loaf height H greater than a predetermined threshold, the controller 14 perform one, some, or all of the following: increase the amount of yeast, decrease the amount of yeast, increase the speed of mixing within the mixing assembly, decrease the speed of mixing within the mixing assembly, increase the amount of water (or other liquid) added, decrease the amount of water (or other liquid) added, increase the oven and/or proofer temperature, decrease the oven and/or proofer temperature, increase the speed at which the dough moves through the forming assembly, and/or decrease the speed at which the dough moves through the forming assembly. The determination by the controller 14 of which input parameters to adjust in response to a baked product height being greater than a predetermined threshold, and the degree of adjustment, may additionally be based on one or more other baked unit parameters, such as height, length, width, moisture content, uniformity, color, mass, moisture content, temperature, shape, surface topography, age, and chemical composition, and/or one or more environmental parameters, such as chamber 204 temperature, chamber 204 humidity, chamber 204 pressure, chamber 204 air composition, and others.

In response to detecting a loaf height H less than a predetermined threshold, the controller 14 perform one, some, or all of the following: decrease the amount of yeast, the speed of mixing within the mixing assembly, increase the amount of water (or other liquid) added, decrease the amount of water (or other liquid) added, increase the oven and/or proofer temperature, decrease the oven and/or proofer temperature, increase the speed at which the dough moves through the forming assembly, and/or decrease the speed at which the dough moves through the forming assembly. The determination by the controller 14 of which input parameters to adjust in response to a baked product height being less than a predetermined threshold, and the degree of adjustment, may additionally be based on one or more other baked unit parameters, such as height, length, width, moisture content, uniformity, color, mass, moisture content, temperature, shape, surface topography, age, and chemical composition, and/or one or more environmental parameters, such as the temperature, humidity, pressure, and/or air composition within the chamber 204.

The sensing element 500 and any sensing element disclosed herein may include one or more of: an infrared sensor, a near infrared sensor, an ultrasonic sensor, a laser range, an optical sensor, a camera, a proximity sensor, a pressure sensor, an accelerometer, and others. For example, the sensing element 500 may comprise a laser range sensor as sensor 502 and also include a camera, where the camera may be mounted adjacent the sensor 502 at the housing, or the camera may be mounted at another location within or at the exterior of the housing 202. The number, variety, and location of the sensors and inputs may vary based on user requirements.

In various aspects of the technology, the controller 14 may determine if one or more of the baked product parameters meet predetermined quality requirements. If the one or more parameters meet the requirements, the controller 14 may then identify the next available rack 206, and the baked product may be moved (e.g., via the carrier system 230) to the available rack 206 and indexed into the available inventory for purchase. If the baked product does not meet the programmed quality requirements it may be moved to an available rack 206, removed from the available inventory for purchase, and an operator may be alerted to remove the baked product and investigate the potential cause and/or the controller 14 may be triggered to evaluate the cause.

In some embodiments, the controller 14 may assign a data profile to the baked product that contains the parameters and store the profiles in a local or remote database. Upon receipt of the baked product by the transition assembly 210 and/or at any time while the baked product is within the kiosk 200, measurements taken by the one or more sensing elements may be communicated to the controller 14 and utilized to update the data profile and/or parameter fields. The data profile may be used to inform startup and calibration requirements for the production process in different environments, control product quality, improve processes, track customer preferences and sales patterns, sort inventory, and inform and direct customer selection and purchase.

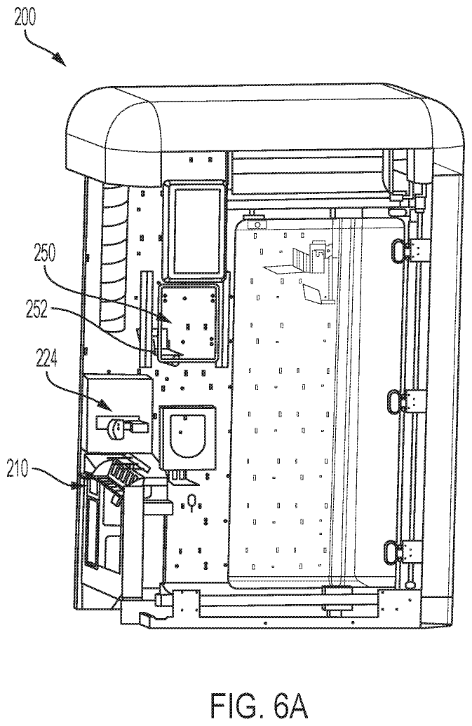

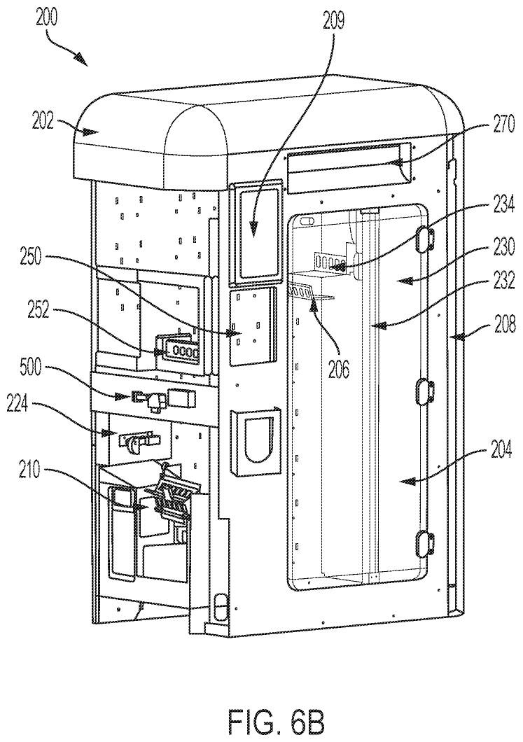

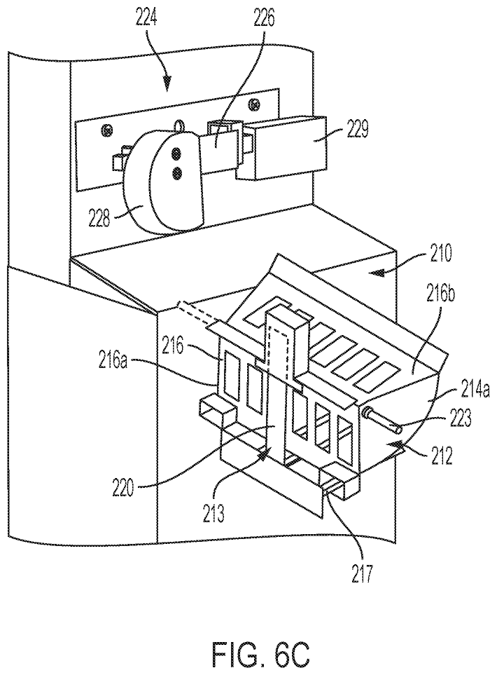

FIGS. 6A and 6B are isometric views of a kiosk 200 comprising another example transition assembly 210 in first and second positions, respectively, in accordance with the present technology. In FIGS. 6A and 6B, various portions of the housing have been removed to show the interior of the kiosk. FIG. 6C is a partially isolated view of the transition assembly shown in FIGS. 6A and 6B. Referring to FIGS. 6A-6C together, in some embodiments the transition assembly 210 may comprise the receptacle 212 and retainer 213 described above with reference to FIGS. 3A-3C, except instead of having an engagement element 222 coupled to the transition assembly 210, the transition assembly 210 of FIGS. 6A-6C includes an engagement assembly 224. The engagement assembly 224 may be coupled to the housing 202, for example, proximate the transition assembly 210. Having a separate engagement assembly 224 as shown in FIGS. 6A-6C may be beneficial as the engagement member 224 may be actuated to contact the pan 158 independent of movement or rotation of the transition assembly 210. The engagement assembly 224 may include an arm 226 configured to move relative to the housing 202 and/or transition assembly 210, and engagement element 228 coupled to a distal region of the arm 226, and an actuator 229 coupled to a proximal region of the arm 226. In some embodiments, the engagement element 228 may have a rounded distal surface, or may have other suitable shapes and configurations. The rounded distal surface may be beneficial for continuously, evenly pushing the pan 158 while the pan 158 rotates.

The actuator 229 may be coupled to the controller 14, and the controller 14 may cause the actuator to extend the arm 226 and engagement element 228 towards the pan 158 and/or production portion 100, or retract the arm 226 and engagement element 228 towards the kiosk. In some embodiments the engagement assembly 224 does not include the engagement element 228 and a distal region of the arm 226 is configured to contact the pan 158.

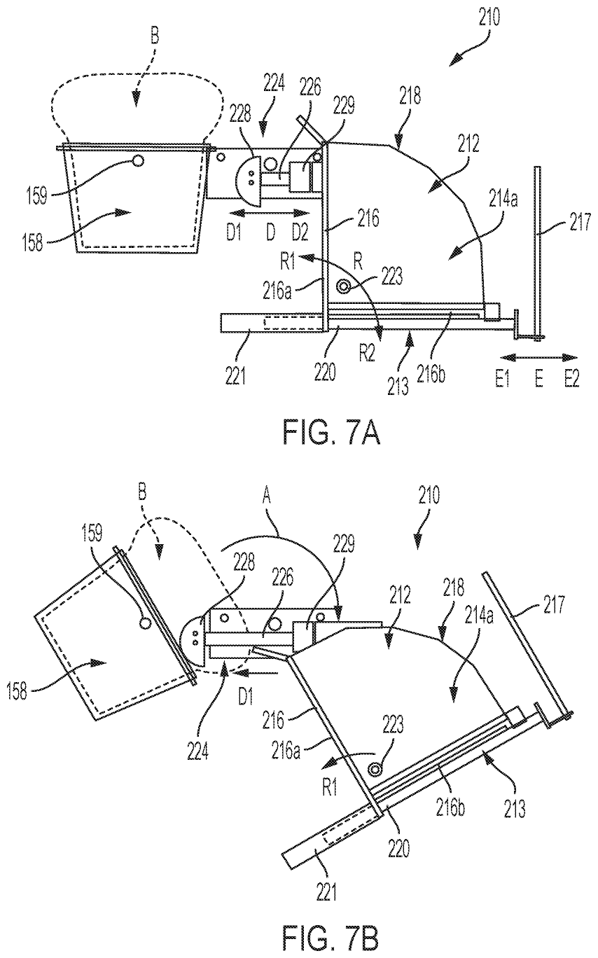

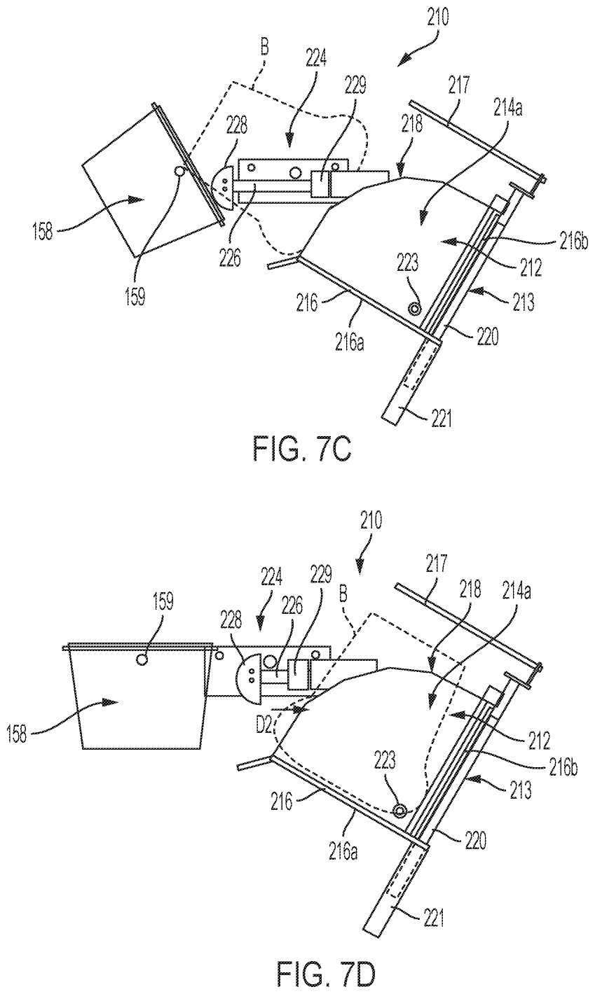

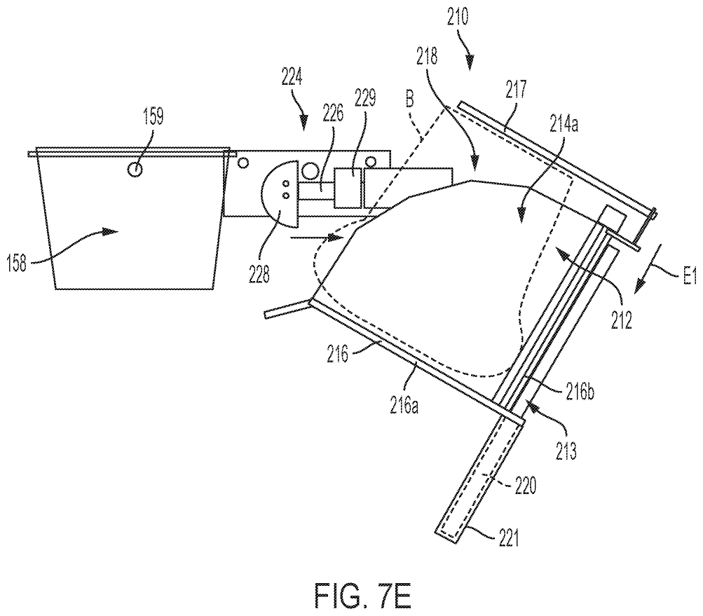

FIGS. 7A-7E schematically illustrate an example method of operating a transition assembly 210 of the present technology, such as the transition assembly 210 shown in FIGS. 6A-6C. To facilitate or expedite the dispensing of the baked product from the pan 158 to the transition assembly 210, the base portion 216 and/or transition assembly 210 may rotate about its longitudinal axis in a first direction R1 until the interior region 218 is facing the pan 158, as shown in FIGS. 7A and 7B. Independent of the rotation of the transition assembly 210, the arm 226 of the engagement member 224 may be extended in a direction away from the transition assembly 210 and towards the pan 158 such that the engagement element 228 comes into contact with the pan 158. The engagement element 228 may be configured to engage a top, body, or bottom portion of the pan 158, or may be configured to engage the pan 158 indirectly by contacting a frame that couples the pan 158 to the oven belt 156.

Further extension of the arm 226 may cause the pan 158 to rotate in a second direction opposite the first direction and towards the transition assembly 210 (as indicated by arrow A in FIG. 7B). Unlike the transition assembly 210 of FIGS. 3A-4G, the transition assembly 210 of the present embodiment moves or rotates independent of motion of the transition assembly 210.

As the arm 226 continues to extend, the engagement element 228 may push or pull the pan 158 such that the pan 158 rotates about the connector 159 towards the kiosk 200 (e.g., the transition assembly 210), as indicated by arrow A in FIG. 7B. In some embodiments, the pan 158 may start (e.g., before contact with the engagement element 228) in a slightly rotated position such that a top surface of the pan is angled towards the transition assembly 210. In some embodiments, the pan 158 may start at a generally level position.

As shown in FIG. 7C, the transition assembly 210 may stop rotating and remain stationary in a first or receiving position. In this first position, the engagement element 228 may be out of contact with the pan 158 or may remain in contact (as shown in FIG. 7C). In some embodiments, the engagement element 228 remains in contact with the pan 158 while at least a portion of the baked product is transferred. Rotation of the pan 158 towards the transition assembly 210 causes the baked product to fall, slide, or otherwise be ejected from the pan 158. The transition assembly 210 may be configured to rotate towards the pan 158 such that the interior region 218 of the transition assembly 210 aligns with the trajectory of the baked product B as it leaves the pan 158. In some embodiments, the baked product B may rotate even after leaving the pan 158 such that a top region of the baked product B lands adjacent the first surface 216a of the base portion 216, as shown in FIG. 7D. In some embodiments, the baked product B may not continue to rotate after being dispensed and instead may enter the interior region 218 sideways and slide along the first surface 216a of the base portion 216 such that a top region of the baked product B is adjacent the second surface 216b of the base portion 216.

The kiosk 200 and/or transition assembly 210 may optionally include a sensor (not shown) configured to confirm the presence of the baked product B in the interior region 218 of the transition assembly 210. Once confirmed, the controller 14 may retract the arm 220 (as indicated by arrow El in FIG. 7E) to bring the fingers 217 into firm contact with the baked product B (as shown in FIG. 7E). In some embodiments, the retraction distance of the arm 220 is predetermined based on the expected size of the baked product B. In some embodiments, the retraction distance may be determined in real-time to accommodate a range of sizes of baked products B. For example, the transition assembly 210 may include a sensor (not shown), such as a photoelectric, pressure, or torque sensor, configured to provide feedback to the controller 14 that the baked product is firmly retained within the transition assembly 210. Once the controller 14 receives data that the baked product is firmly retained, the controller 14 may cause the actuator (not shown) to cease movement of the arm 220. Before, during, or after detection of the presence of the baked product within the transition assembly 210 and/or movement of the arm 220, the controller 14 may retract the arm 226 of the engagement assembly 224 (as indicated by arrow D2 in FIG. 7D).

With the baked product in the transition assembly 210, the controller 14 may cause the transition assembly 210 to rotate in a second direction R2 away from the pan 158 (as described with respect to FIG. 4E), towards the chamber 204 of the kiosk 200 and into a second or offloading position (as described with respect to FIG. 4F). The transition assembly 210 may continue to rotate in the second direction until the baked product is upward facing and resting on the fingers 217. In some embodiments, the arm 220 may be extended to increase the bound volume of the interior region 218 such that the weight of the baked product rests on the extension 270.

Referring again to FIGS. 2A-2C, the carrier system 230 may include horizontal and vertical tracks 232, a plurality of actuators, and a support assembly 234 configured to move along horizontally and vertically within the chamber 204 via the tracks 232. The support assembly 234 may be configured to receive one or more of the baked products from the transition assembly 210 and move within the chamber 204 to deliver the baked product to a predetermined receptacle or rack 206. In some embodiments, the carrier system 230 may optionally include a sensor to confirm the presence of the baked product on the support assembly 234.

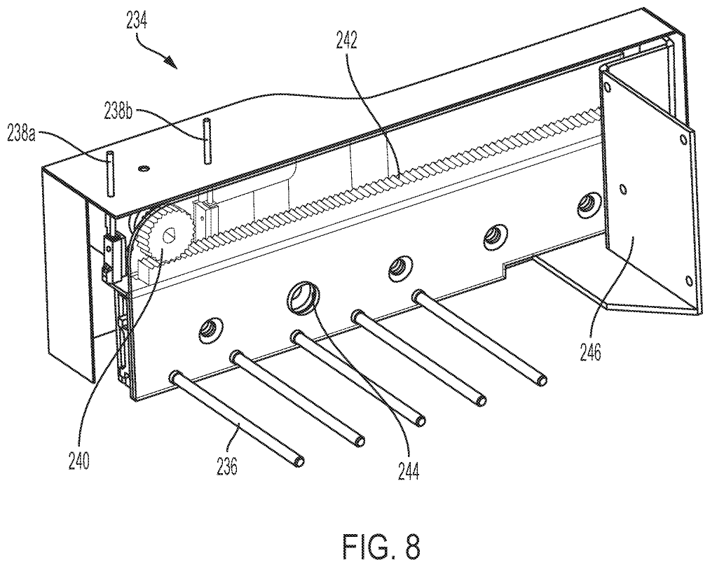

FIG. 8 is an isolated view of an example support assembly 234 of a carrier system 230 configured in accordance with the present technology. As shown in FIG. 8, the support assembly 234 may include a housing, a plurality of fingers 236 extending away from the housing, a sensing element comprising sensors 238a and 238b, a sensing element 244 directed towards the extension of the fingers 236, an end plate 246, a gear 240, and a track 242. The end plate 246, housing, and fingers 236 may together form an L-shape. The sensing element 244 may be configured to detect if the baked product has been transferred from the transition assembly 210 to the support assembly 234 (e.g., to the fingers 236). Sensors 238a and 238b may extend upwardly from the housing and function as the open and close sensors for the Z delivery arm. Sensors 238a and 238b may be configured to sense a metal flange through non-contact proximity sensing.

One, some, or all of the transition assembly 210, customer tray 232, the support assembly 234, and the rack(s) 206 may all be configured as combs in which teeth or fingers are spaced apart. The neck, teeth and openings of the support assembly 234, for example, may be offset 180 degrees from the neck, teeth and openings of the transition assembly 210 and/or the rack(s) 206 so that the fingers 236 of the support assembly 234 may move vertically through the openings between the fingers 217 of the retainer 213 and/or the teeth of the rack 206. In some instances, the hand off between (a) the transition assembly 210 and the support assembly 234 and/or (b) the support assembly 234 and the rack 206 occurs by passing the fingers 236 of the support assembly 234 through the openings of the opposing tray. The support assembly 234 may pass up through the transition assembly 210 to pick up the baked product and the support assembly 234 passes down through the openings of the rack 206 to transfer the baked product to the rack 206. The hand off between other elements of the kiosk may occur in a similar fashion.

The carrier system 230 may be configured to transport a baked product to any rack 206 within the chamber 204 or retrieve a baked product from any rack 206 within the chamber 204. When the carrier system 230 receives a baked product from the transition assembly 210, it may query the controller 14 for the next available rack 206 and corresponding coordinates. The carrier system 230 may move the support assembly 234 to a position opposite the rack 206 identified by the controller 14, and the actuator may extend to position the support assembly 234 just above the targeted rack 206 in the same vertical plane. The carrier system 230 may then move the support assembly 234 down below the rack 206, passing the teeth of the support assembly 234 through the openings in the rack 206, leaving the baked product in the rack 206. After depositing the baked product, the carrier system 230 may actuate back to its home position or enter into a sorting cycle in which the baked product is organized from warmest to coolest and open spaces are consolidated and available for new loaves exiting the production portion 100. In some embodiments, once a predetermined number of rack 206 or row or rows of racks 206 are full, the operator may be notified so that the baked product may be sliced, bagged, and placed on a display shelf

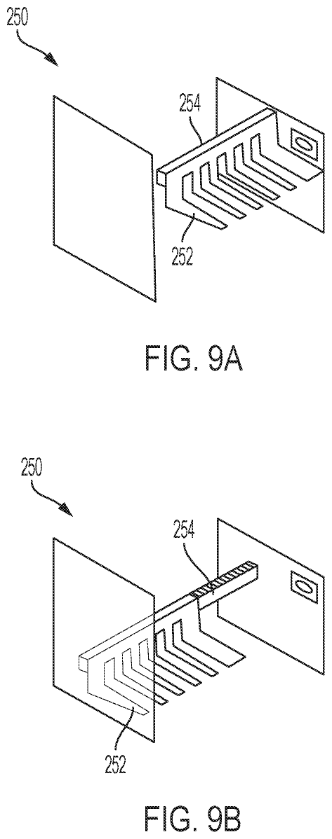

FIGS. 9A and 9B are isolated views of an example dispensing assembly 250 in accordance with the present technology, shown with a customer tray in a retracted position and an extended position, respectively. With reference to FIGS. 2A-2C and 9A-9B, the dispensing assembly 250 may be configured to receive a baked product from the carrier system 230 and temporarily holds the baked product for the customer to remove. The baked product may be transferred to the customer via an opening in the housing 202 through which the customer may receive the baked product. The dispensing assembly 250 may include, for example, a customer tray 252 (see FIGS. 2B and 2C) and an actuating arm 254 coupled to the customer tray 252 and the housing 202. The customer tray 252 may comprises a rack or other similar device that temporarily holds and supports the baked product, and the actuating arm 254 may be configured to move the baked product towards the opening of the dispensing assembly 250. In some embodiments, the actuating arm 254 is configured to move all or a portion of the customer tray 252 (and its contents) through the opening for removal by the customer. In some embodiments, the actuating arm 254 only moves the customer tray 252 within the dispensing assembly 250.

The dispensing assembly 250 may be safety protected with a light curtain safety sensor. If the light curtain is broken, the support assembly 234 may not move within the plane of the dispensing assembly 250. Similarly, the door 208 may be monitored by a contact sensor such that, if the door 208 is opened, the support assembly 234 may not move and/or an alarm may be triggered. The light curtain safety sensor may also be used to confirm if a customer has reached into the dispensing region and handled the baked product.

Referring back to FIGS. 2A and 2B, the kiosk 200 may include a touchscreen 209 for customer input and ordering. A customer may select their baked product based on a desired finished attribute such as warmest baked product or ready for slicing and bagging. Alternatively, the customer may select any available baked product based on its physical position within the cabinet or other identification marker such as a number plate on the rack 206. After selection by the customer, the controller 14 may send the support assembly 234 to retrieve the desired baked product based on the indexed data profiles and corresponding coordinates. The support assembly 234 may retrieve the warmest baked product, whether on the transition assembly 210 or a rack 206, and transport it to and deposit it on the customer tray 232 in the dispensing assembly 250. If the customer takes the baked product within a predetermined time interval (e.g., 40 seconds), the carrier system 230 may return to its home position. If the customer does not retrieve the baked product within the predetermined time interval, and the customer has not broken the light curtain safety sensor, the carrier system 230 may return the baked product to the rack 206. If the customer handles the baked product and returns it to the dispensing assembly 250, the carrier system 230 may return the baked product to an available rack 206, remove it from the available inventory for purchase, and an operator may be alerted to remove the baked product and investigate the potential cause.

In some embodiments customer input and ordering may occur through a mobile or Web based application. Mobile and Web based orders may be linked to a stored customer profile and may allow a customer to save favorite recipes and modifications, order ahead for a specific time and place pickup, pre-pay for their product, and receive personalized coupons or suggestions based on the customer profile and habits. After ordering through a mobile or Web based application, a customer could retrieve their order as the selected kiosk through the touchscreen interface 209.

In some embodiments, the kiosk 200 may optionally include a vent pipe and blower 270 to draw the aroma of fresh baked product of the kiosk 200 and out into the surrounding environment (i.e., a store).

The kiosk 200 may include one or more sensing elements positioned within the chamber 204 and configured to track the position and movements of the baked product throughout the chamber 204 and/or to obtain measurements of the baked product while the baked product is within or otherwise engaged by the kiosk 200. A data profile comprising one or more of the baked product parameters (including those obtained by sensing element 500) may be communicated to the remote server and accessible via a mobile or Web application to a potential customer.

The baked product parameters may also be used to improve the overall performance of the production process including identifying patterns that lead to exceptional or substandard loaves to inform decisions on adjustments such as baking or proving temperature, mixing speed, water level, baking time, etc. The process improvements may be automated based on feedback loops from controller 14 or manually adjusted by the operator. The process improvements may be based on feedback from an individual system 10, or the feedback from multiple networked systems 10. For example, a system being installed and operated in a high elevation and dry environment might adjust its default recipes and production processes based on the performance of other units in high elevation and dry environments. Likewise, a system 10 being installed and operated in an environment with hard water may adjust its recipes and processes based on other systems 10 operating with hard water.

### II Additional Embodiments

The system 10 may include more or fewer components than those discussed above. For example, the production portion 100 may include more or fewer sub-assemblies than those shown in FIGS. 1A and 1B, and the kiosk 200 may include more or fewer sub-assemblies than those shown in FIGS. 1A and 1B. For example, as shown schematically in FIG. 9B, in some embodiments the production portion 100 may include one or more dividing assemblies 80 configured to split, cut, pour, or otherwise apportion the lump of dough into separate smaller portions. The dividing assembly(s) 80 may be positioned along the production path between the mixing assembly 130 and the forming assembly 140 and/or between the forming assembly 140 and the oven 150. Additionally or alternatively, the production portion 100 may include a garnishing assembly 90 to coat, glaze, salt, score, and/or sprinkle additional ingredients or supplements onto the baked product prior to baking.

In some embodiments, the system 10, production portion 100, and/or kiosk 200 may include and/or be coupled to one or more finishing units which provide the customer with the option to modify their baked product. For example, the system 10, production portion 100, and/or kiosk 200 may include one or more of: a glazing unit comprising one or more applicators, such as one or more brushes, sprayers, rollers, etc. and configured to apply a glaze, frosting, icing, butter, jam, jelly, etc., to the baked product; a slicing unit comprising one or more vibrating, reciprocating, and/or rotating blades configured to slice the baked product; a toasting unit comprising one or more heating elements (e.g., one or more infrared heating elements) configured to toast the baked product (pre- or post-slicing, if applicable); a topping unit comprising one or more applicators, such as one or more shakers, sprayers, and configured to garnish the baked product with nuts, seeds, salt, sprinkles, powders, etc.; and a packaging unit configured to package the baked product (e.g., in a bag, a box, etc.) for travel and/or storage.

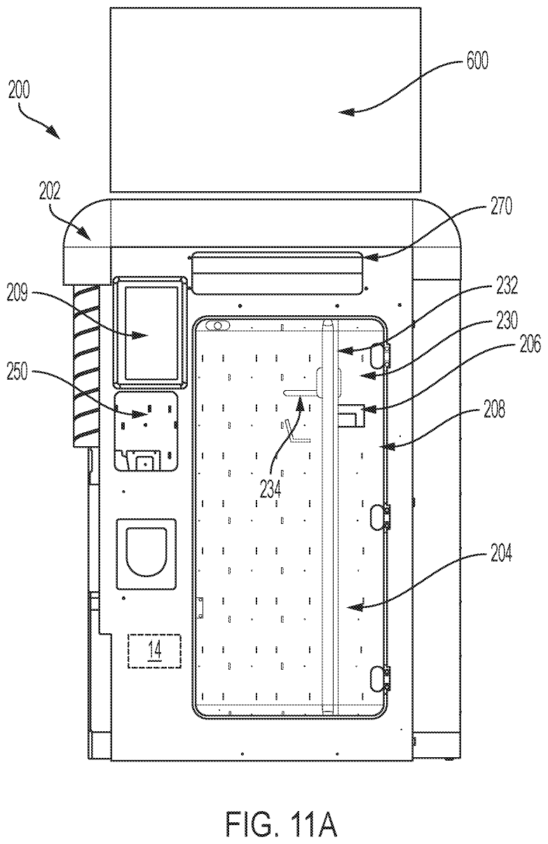

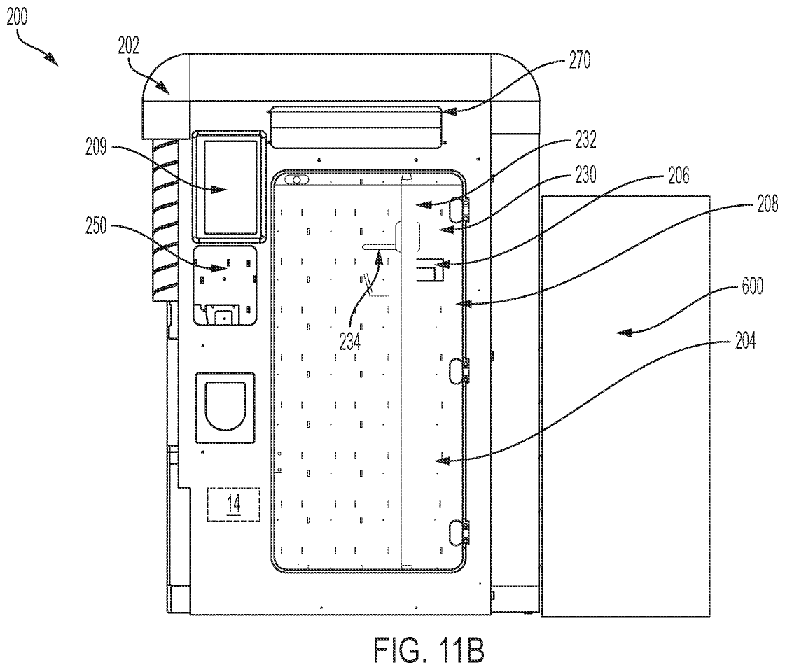

The one or more finishing units may be coupled to the kiosk 200 by sitting on top of the unit within the same footprint (see, for example, FIG. 11A), or adjacent to the kiosk and on top of one another (see, for example, FIG. 11B). For finishing units on top of the kiosk 200, the housing 202 may include an opening at its top and the vertical track 232 of the carrier system 230 may extend up through this opening so that the baked product can be deposited in the finishing unit. For finishing units next to the kiosk 200, the housing 202 may include an opening on its side and the horizontal track 232 of the carrier system 230 may extend out through the opening so that the baked product can be deposited in the selected adjacent finishing units. Depending on the application, the finishing units may be configured in parallel or series so that any given order could be finished in multiple ways, for instance a loaf of bread could be sliced, toasted, buttered, and boxed before delivery to the customer by utilizing the slicing unit, toasting unit, glazing unit, and packaging unit.

### III. Customization

In some embodiments, the system 10 may be configured to customize the amount of data provided to the customer. For example, in some embodiments the customer may access the data for all finished product attributes to select their preferred baked product from the current inventory. Alternatively, the customer could use the range of finished product attributes or to order a baked product specific to their preferences. For example, a customer could order the warmest or freshest baked product, or the lightest baked product from the current available inventory, or a special-order product (for example, a baked product with extra seeds in it). Based on an analysis by the controller 14, the customer might be informed that their baked product is forecast to potentially be of marginal quality and not recommended. The controller may offer corrective measures to improve baked product quality, alternative recipes to consider, or provide the customer with the option to proceed with the order. In some embodiments, the controller may be equipped to accept payment at the kiosk 200. Payment may occur at various points in the process including pre-payment for custom orders, or post payment for orders from existing stock.

In some embodiments, the controller 14 may report to the user an analysis of the unique nutritional values of their specific loaf. In some instances, the controller 14 may advise the user what proportion of the researcher's recommended daily intake is present in each serving. The controller 14 may base its analysis on a fractional value of the baked product (such as a per-slice value), which in turn depends on the fractional properties, such as thickness, which the slicer-bagger system may offer as a variable. The controller 14 may also provide the user with the option to augment their selected loaf with additional ingredients to improve its nutritional value or health benefits.

In some embodiments, the system 10 may be configured to deliver specific, customized nutrition labels for all personalized loaves. The labels could be delivered via app/text, or by printed, self-adhesive labels. The system 10 may be configured to advise the user via a web or mobile app or via text message that their baked products are currently being prepared, are now ready for pick-up, etc.

### Conclusion

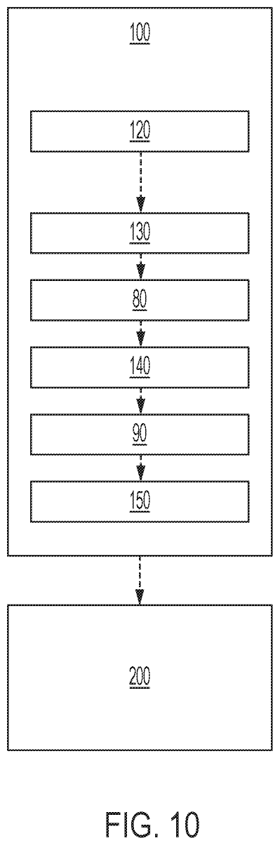

Although many of the embodiments are described above with respect to systems, devices, and methods for storing and distributing a baked product, the technology is applicable to other applications and/or other approaches, such as storing any perishable good. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-11B.

The above detailed descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

1. A kiosk for storing, displaying, and distributing a plurality of baked units, the kiosk comprising:
a housing defining a chamber therein;
a transition assembly positioned at least partially within the chamber and configured to support one or more of the baked units;
a carrier configured to move horizontally and vertically within the chamber, the carrier being configured to receive and carry one or more of the baked units;
one or more sensing elements configured to obtain data associated with one or more of the baked units along the production path, then data comprising baked unit parameters including one or more of a height, a color, a surface topography, a temperature, a volume, and/or a shape of the individual baked units;
a plurality of racks disposed within the chamber and individually configured to support one or more of the baked units;
a controller coupled to the carrier and the sensors, the controller comprising tangible, non-transitory, computer-readable media storing instructions executable by the processor to cause the kiosk to perform one, some, or all of the operations comprising:
retract a portion of the transition assembly towards the baked unit,
rotate the transition assembly and baked unit towards the carrier,
move the carrier proximate the transition assembly to transfer the baked unit from the transition assembly,
move the carrier away from the transition assembly to deliver the baked unit to one of the plurality of racks, and/or move the carrier to retrieve a particular baked unit from its rack and deliver the particular baked unit to the dispensing area.

2. The kiosk of claim 1, further comprising a dispensing area within the chamber comprised of an actuator, a tray, and an opening in the chamber through which a customer may retrieve the particular baked unit.

3. The kiosk of claim 1, wherein the carrier is moveable along vertical and horizontal tracks positioned within the chamber, and wherein the carrier includes an extender that is configured to extend and retract in a direction generally orthogonal to the vertical and horizontal tracks.

4. The kiosk of claim 1, wherein the carrier includes an extender that is configured to extend away from the carrier towards one of the racks proximate the carrier to deliver a baked unit to the rack.

5. The kiosk of claim 1, wherein the kiosk is a standalone kiosk.

6. The kiosk of claim 1, wherein the housing surrounds the chamber such that an internal environment of the chamber is self-contained.

7. The kiosk of claim 1, wherein the chamber has a controlled temperature.

8. The kiosk of claim 1, wherein the chamber has a controlled pressure.

9. The kiosk of claim 1, wherein the chamber has a controlled humidity.

10. The kiosk of claim 1, wherein the kiosk is configured to be coupled to an adjacent kiosk, and wherein the adjacent kiosk provides the baked unit to the transition assembly of the kiosk.

11. The kiosk of claim 1, wherein a side portion of the housing includes an opening through which the adjacent kiosk transfers the baked unit to the kiosk.

12. The kiosk of claim 1, wherein the controller receives data from the one or more sensors characterizing one or more of the baked unit parameters and compares the data to a predetermined data set of baked unit parameters.

13. A method for providing and distributing baked units, the method comprising:
automatically receiving a baked unit into a receiving element positioned at least partially within a chamber of a kiosk;
automatically moving the baked unit from the receiving element to an empty rack via a carrier configured to move horizontally and vertically within the chamber; and
in response to receiving a request for a particular baked unit, moving the carrier to retrieve the particular baked unit and delivering the particular baked unit to a repository in the kiosk through which a customer may retrieve the particular baked unit.

14. The method of claim 13, wherein, in response to a baked unit carried by the carrier moving outside of a range of a sensor, counting a number of increments moved by the carrier before leaving the range of the sensor.

15. The method of claim 14, further comprising calculating the height of the baked unit based on the number of increments.

16. The method of claim 13, wherein receiving the baked unit includes receiving the baked unit from a user.

17. The method of claim 13, wherein receiving the baked unit includes receiving the baked unit automatically from an oven.

18. The method of claim 17, wherein the kiosk is a first kiosk and the oven is integrated with a second kiosk.

19. The method of claim 18, wherein receiving the baked unit from the second kiosk includes receiving the baked unit from an oven of the second kiosk.

20. The method of claim 13, wherein the baked unit is a loaf of bread.

21. The method of claim 13, wherein the baked unit is a first baked unit and receiving the first baked unit from the second kiosk occurs at a first time, and wherein the method further includes receiving a second baked unit from the second kiosk at a time.

22. The method of claim 21, wherein the first baked unit is a first loaf of bread and the second baked unit is a second loaf of bread that is a different type of bread than the first loaf of bread.

23. The method of claim 21, wherein the first baked unit is a first loaf of bread and the second baked unit is a second loaf of bread that is a size than the first loaf of bread.

24. The method of claim 21, wherein the second time is within six minutes of the first time.

25. The method of claim 21, wherein the second time is within five minutes of the first time.

26. The method of claim 21, wherein the second time is within two minutes of the first time.

27. The method of claim 21, wherein the second time is within one minute of the first time.

28. The method of claim 21, wherein the time between automatically receiving the baked unit into the receiving element and when the controller displays the baked unit for selection by a customer is 30 seconds or less.
